(19) United States
(12) Patent Application Publication
(10) Pub. No.: US 2025/0271271 A1
(43) Pub. Date: Aug. 28, 2025

(54) A DATA PROCESSING METHOD OF AN INDOOR POSITIONING SYSTEM FOR SCALABILITY IMPROVEMENT

(71) Applicant: SIGNIFY HOLDING B.V., EINDHOVEN (NL)

(72) Inventors: MENG ZHAO, EINDHOVEN (NL); MARK HENRICUS VERBERKT, EINDHOVEN (NL); JULES MARTINUS ADRIANUS GERARDUS DE LAAT, BOXTEL (NL); JOHANNES ANTONIUS WILHELMUS MARIA VAN CRANENBROEK, BUDEL (NL)

(21) Appl. No.: 18/859,680

(22) PCT Filed: Apr. 17, 2023
(86) PCT No.: PCT/EP2023/059915

§ 371 Date: Oct. 24, 2024

(30) Foreign Application Priority Data
Apr. 25, 2022 (EP) 22169621.4

(51) Int. Cl. G01C 21/20

(52) U.S. Cl. CPC G01C 21/206

(57) ABSTRACT

A data processing method (600) for indoor positioning system (100) comprising steps of: providing (S601) configuration information to a mobile device (200); detecting (S602) raw localization data by the mobile device (200); pre-processing (S604) the raw location data by using the configuration information, upon determining (S603) by the mobile device (200) to carry out preprocessing locally; sending (S605) pre-processed localization data to a cloud server (300) or a local server (400) on premises.

### FIELD OF THE INVENTION

The invention relates to the field of data processing for indoor positioning system. More particularly, various apparatus, systems, and methods are disclosed herein related to scalability improvement of an indoor positioning system.

### BACKGROUND OF THE INVENTION

In an indoor positioning enabled system, a mobile device that runs a positioning software (e.g., IPS SDK) can detect the device location use various technologies include visual light communication, blue tooth triangulation etc. The software then derives the location of the device represented either in an absolute manner such as geographic locations or a relative manner such as a location on a floorplan map. In the former case, the floorplan map image is often annotated with geographic reference points to enable mapping of pixel position on the floorplan to absolute geographic location describe with latitude and longitude. The mobile device sends the detected positions periodically to the cloud for further processing and analytics.

When the indoor positioning system was designed for indoor navigation application, the expected number of mobile devices that generate location data is limited. However, nowadays the system is expanding with the feature to also enable data analytics on the how and where the customers visit and stay in the indoor space. As the customer base and number of mobile devices increase, large amount data will be sent to the cloud for processing. The webservice that handles the location data needs to be upscaled to cope with the amount of data, thus will increase the cost and decrease the system stability.

U.S. Pat. No. 8,396,254B1 relates to a method and system for estimating a location of a robot, which comprises a robot capturing range images indicating distances from the robot to a plurality of objects in an environment, transmitting to a server a query based on the range images, receiving from the server a mapping of the environment and estimating a location of the robot.

### SUMMARY OF THE INVENTION

In an indoor environment, with a localization enabled mobile device, the location of the device can be detected and provided to a local server or a remote serve in the cloud. With such location data, analytics on certain key performance indicators, such as footfall, density, and dwell-time, can be calculated over spaces and temporal intervals, which may provide high business values. However, with the increasing number of mobile devices and consequently the amount of location data, a data processing overhead on the server, especially a cloud server, may increase substantially and lead to higher cost and lower scalability of the system. In this invention, a new processing method is proposed to alleviate the load on the server, and thus increase the scalability of the system.

More particularly, the goal of this invention is achieved by a data processing method for indoor positioning system as claimed in claim 1, and by an indoor positioning system as claimed in claims 12-15, respectively.

In accordance with a first aspect of the invention a data processing method is provided. A data processing method for indoor positioning comprising steps of providing configuration information to a mobile device; detecting raw localization data by the mobile device; pre-processing the raw localization data by using the configuration information, upon determining by the mobile device to carry out preprocessing locally; sending pre-processed localization data to a cloud server or a local server on premises; wherein the configuration information comprises a dimension in pixels of a floorplan and a grid size in pixels or in an absolute length unit, and the grid size is configurable and defines the precision of the pre-processed localization data;

wherein the pre-processing step further comprises:
mapping the raw localization data to a grid index; wherein the pre-processed localization data comprises the grid index.

The mobile device may be a mobile phone, a tablet, a laptop, a wearable device, a handheld scanner, or another portable electronic device.

To process the raw localization data on the device locally, certain computation capability is required. This may not be a problem for an advanced device, such as a smartphone, but it could be a burden for a low-end device such as a handheld scanner in a supermarket. Furthermore, even if the mobile device has the computation capability, it may not be always available for this task. For example, sometimes the mobile device may be busy with some other important assignments, thus cannot allocate sufficient resources on this dedicated data processing task.

It is thus beneficial that the mobile device may first evaluate its capability and/or status and decide whether to run this pre-processing step. If a mobile device determines not to carry out preprocessing locally, it may simply send the raw localization data to the local server or the cloud server.

Beneficially, the mobile device determines to carry out preprocessing locally only when there is sufficient processing resource on the mobile device to process the raw localization data. If the mobile device determines that it is capable to carry out the preprocessing locally, it will first do the pre-processing locally and then send the pre-processed localization data to the local server or the cloud server.

The configuration information may be dedicated to the location and/or the application in the field. Based on the configuration information. the pre-processing step is then used to extract more business-relevant localization data out of the raw data. For example, the raw localization data may be reformulated with a certain level of extraction for producing statistics with higher commercial values. The absolute geographic location of the device may be represented in a simplified format that links to a certain application or business.

Beneficially, the data processing method further comprises a step of sending raw localization data to the cloud server or the local server.

It can be useful that the pre-processed localization data are sent in combination with the raw localization data. When necessary, the local server or the cloud server may carry out further computation with the raw localization data to derive additional information other than the pre-processed data received from the mobile device. For example, the local server or the cloud server may use different extraction to re-organize the data and/or to combine data obtained from different locations to derive other business-interesting information.

Preferably, the configuration information comprises a dimension in pixels of a floorplan and a grid size in pixels or in an absolute length unit.

With a dimension in pixels of a floorplan, the mobile device may derive a mapping between the actual dimension of the field and the dimension in pixels. A further information on a grid size may be communicated either in pixels or in an absolute length unit, such as in centimeter (cm), decimeter (dm), or meter.

In one example, a two-dimensional grid to a pixelated floorplan, wherein each rectangular grid cell comprises a (same) integer number of pixels. Alternatively, each rectangular grid cell is of same length and width represented in an absolute length unit.

The grid size defines the precision of the pre-processed localization data, which may be configured according to the application. This may be used to reduce the size or length of localization data by keeping only the necessary precision of the localization data. With a reduced size or length of the localization data, the computation overhead to derive further information will also be reduced. This also saves the communication resource for transmitting the localization date from the mobile device to the local server or the cloud server.

In one example, the pre-processing step further comprises mapping the raw localization data to a pixel coordinate or grid index; and the pre-processed localization data comprises the pixel coordinate or grid index.

Beneficially, the configuration information further comprises a zone definition represented by a collection of grid indexes.

A zone may be a smallest unit defined according to the relevant application for producing the statistics on the localization date.

In another example, the pre-processing step further comprises the step of mapping the raw localization data to a zone index; wherein the pre-processed localization data comprises the zone index.

Advantageously, a zone is defined according to a category of products or a functional space.

Note that a category of products may be defined according to different classification. For example, in a supermarket, different zones may be defined for different product categories, such as fruits, vegetables, dairy, meat, beverage, bakery, etc. In another example, different zones may also be defined for a sub-category of the products (e.g., apples, bananas, oranges, etc., within the same fruit category).

In an office environment, different zones may be defined for individual offices, meeting rooms, and coffee corners.

Preferably, the configuration information further comprises a zone group definition represented by a collection of zones.

With a further level of extraction, a zone group may combine a collection of zones. And then the local server or the cloud server may use different levels of extracted data for different applications.

In one example, the pre-processing step further comprises a step of mapping the raw localization data to a zone group index, and the pre-processed localization data comprises the zone group index.

In a preferred setup, the raw localization data is detected by the mobile device via visible light communication, a Bluetooth Low Energy radio, an Ultra-wideband radio, or a combination therefrom.

Advantageously, the configuration information is provided to the mobile device either by the cloud server or by the local server.

The local server is located on premises. For example, it may be placed at the entrance to a building, or at the entrance to a floor in the building, or at the entrance to a big hall. The configuration information related to the building, the floor, or the hall is stored in the local server, and provided to the mobile device when it passes by the local server, such as via a short-range wireless communication technique or via a local area network.

Alternatively, the configuration information may be stored in the cloud server and provided to the mobile device via a wireless network connected to the cloud.

In accordance with a second aspect of the invention, an indoor positioning system is provided. The indoor positioning system comprises a local server on premises configured to provide configuration information to a mobile device; and the mobile device configured to detect raw localization data; pre-process the raw localization data by using the configuration information, upon determining to carry out preprocessing locally in the mobile device; and send pre-processed localization data to the local server; wherein the configuration information comprises a dimension in pixels of a floorplan and a grid size in pixels or in an absolute length unit, and the grid size is configurable and defines the precision of the pre-processed localization data;

wherein the mobile device is further configured to map the raw localization data to a grid index to pre-process the raw localization data, and the pre-processed localization data comprises the grid index.

The mobile device may also be further configured to send the raw localization data to the local server.

In accordance with a further aspect of the invention, an indoor positioning system is provided. The indoor positioning system comprises a cloud server configured to provide configuration information to a mobile device; and the mobile device configured to detect raw localization data; pre-process the raw localization data by using the configuration information, upon determining to carry out preprocessing locally in the mobile device; and send pre-processed localization data to the cloud server; wherein the configuration information comprises a dimension in pixels of a floorplan and a grid size in pixels or in an absolute length unit, and the grid size is configurable and defines the precision of the pre-processed localization data;

wherein the mobile device is further configured to map the raw localization data to a grid index to pre-process the raw localization data, and the pre-processed localization data comprises the grid index.

The mobile device may also be further configured to send the raw localization data to the cloud server.

In accordance with a further aspect of the invention, an indoor positioning system is provided. The indoor positioning system comprises a local server configured to provide configuration information to a mobile device; a cloud server; and the mobile device configured to detect raw localization data; pre-process the raw localization data by using the configuration information, upon determining to carry out preprocessing locally in the mobile device; and send pre-processed localization data to the cloud server; wherein the configuration information comprises a dimension in pixels of a floorplan and a grid size in pixels or in an absolute length unit, and the grid size is configurable and defines the precision of the pre-processed localization data;

wherein the mobile device is further configured to map the raw localization data to a grid index to pre-process the raw localization data, and the pre-processed localization data comprises the grid index.

The mobile device may also be further configured to send the raw localization data to the cloud server.

In accordance with a further aspect of the invention, an indoor positioning system is provided. The indoor positioning system comprises a cloud server configured to provide configuration information to a mobile device; a local server on premises; and the mobile device configured to detect raw localization data; pre-process the raw localization data by using the configuration information, upon determining to carry out preprocessing locally in the mobile device; send pre-processed localization data to the local server; wherein the configuration information comprises a dimension in pixels of a floorplan and a grid size in pixels or in an absolute length unit, and the grid size is configurable and defines the precision of the pre-processed localization data;

wherein the mobile device is further configured to map the raw localization data to a grid index to pre-process the raw localization data, and the pre-processed localization data comprises the grid index.

Beneficially, the cloud server is configured to schedule computing resource on the cloud server for handling localization data submitted by a mobile device according to a processing capability of the mobile device and/or business hours of a site that the mobile device is located.

The cloud server may have to handle huge amount of data from multiple sites over different regions. It may be more efficient if the computing resource is scheduled according to the demand from an individual site. For example, the cloud server may take into account a typical processing capability of the mobile devices over that site, and/or the business hours of that site into account. When it is during business hours, more resource will be reserved for that site to handle localization data submitted by the mobile devices in that site. When it is out of business hours, the cloud server may release the reserved resource for that site and re-allocate to other sites.

### BRIEF DESCRIPTION OF THE DRAWINGS

In the drawings, like reference characters generally refer to the same parts throughout the different figures. Also, the drawings are not necessarily to scale, emphasis instead generally being placed upon illustrating the principles of the invention.

FIG. 1 shows a flowchart of a data processing method;

FIG. 2 illustrates an example of an indoor positioning system according to the present invention;

FIG. 3 illustrates another example of an indoor positioning system according to the present invention; and

FIG. 4 illustrates a further example of an indoor positioning system according to the present invention.

### DETAILED DESCRIPTION OF EMBODIMENTS

The embodiments set forth below represent information to enable those skilled in the art to practice the embodiments. Upon reading the following description in light of the accompanying drawings, those skilled in the art will understand the concepts of the disclosure and will recognize applications of these concepts not particularly addressed herein. It should be understood that these concepts and applications fall within the scope of the disclosure.

In an indoor positioning enabled system, the mobile device, with the aid of different sensing technologies and a positioning software (e.g., IPS SDK), can detect the device location. The location information of the device may be represented either in absolute manner such as geo locations or relative manner such as location on a floorplan map. In the former case, the floorplan map image is often annotated with geo reference points to enable mapping of pixel position on the floorplan to absolute geo location describe with latitude and longitude. The mobile device sends the detected positions periodically to the cloud for further processing and analytics.

A professional user, such as facility manager of the building, defines zones that each is a polygon with several points on the floorplan image. A zone can represent a category of product shelfs in the supermarket, or a functional space in the warehouse or office. Statistics of footfalls, dwell-time and density of the device locations can provide information such as how spaces are being used, which category of products are most attractive to the customer etc.

In the existing system, the locations of the devices are represented with latitude and longitude to maintain sufficient precision. The cloud service divides the floorplan into non-overlapping grid in square shape with predefined size. Upon receiving the locations of the mobile devices, the cloud service first determines to which grid each reported location belongs to, then uses the center of such grid to represent the location to reduce the amount of data to be processed in the later stage.

When the indoor positioning system was designed for indoor navigation application, the expected number of mobile devices that generate location data is limited. However, the system is expanded with the feature to also enable data analytics on the how and where the customers visit and stay in the indoor space. As the customer base and number of mobile devices increase, large amount of data will be sent to the cloud for processing. The webservice that handles the location data needs to be upscaled to cope with the amount of data, thus will increase the cost and decrease the system stability.

Considering that each mobile device sends its location (include latitude, longitude, altitude and metadata) of each second, this will lead to 60 locations per mobile device per minute. In one example, with 200 sites and 100 mobile devices per site, in total 8 million locations will need to be processed in the cloud.

As an example, for each location data received in the cloud, the follow processing may be performed:
1. Divide the floorplan into grid with fixed size (e.g., 30×30 cm);
2. Calculate to which grid the location belongs to;
3. Determine to which zone and zone group the location belongs to;
4. Calculate the total footfall dwell time of each zone and zone group, take into account whether it is the same customer trip;
5. Generate the density map by calculate the number of locations in each grid.

This invention proposes to distribute the pre-processing of the location data over the large number of mobile devices, thus, to reduce the amount of computation centrally in a local server or in a remote server in the cloud. When cloud service receives the location data, the pre-processed results is also provided, thus makes the calculation of the grid group, footfall and dwell time straight forward.

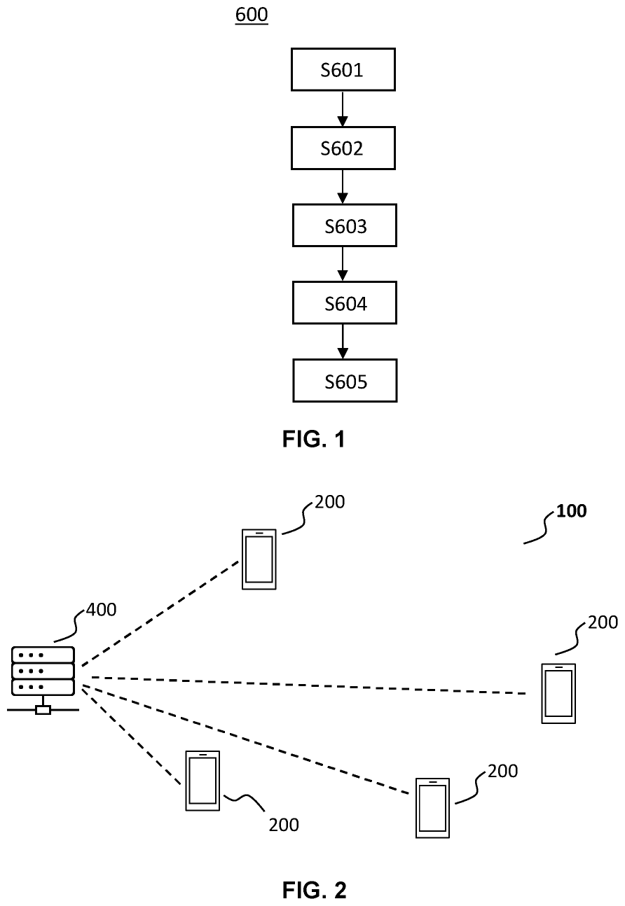

FIG. 1 shows a flowchart of a data processing method 600. The data processing method 600 for an indoor positioning system 100 comprises steps of: providing in step S601 configuration information to a mobile device 200; detecting in step S602 raw localization data by the mobile device 200; pre-processing in step S604 the raw location data by using the configuration information, upon determining in step S603 by the mobile device 200 to carry out preprocessing locally; and sending in step S605 pre-processed localization data to a cloud server 300 or a local server 400 on premises.

To enable the pre-processing of the data on the mobile device, a local server, a remote server, or a cloud service needs to communicate configuration information to the mobile devices, such as:
1. The dimension (width×height) in pixels of the building floorplan image(s). Note, the real floorplan map could be available already on the mobile device for navigation purpose, which is very often in a vector format. Here the mobile devices only need the floorplan image dimension to avoid ambiguity introduced by scaling.
2. The reference points (normally 3) to map the pixel position to physical latitude and longitude and vice versa.
3. The grid size in either number of pixels or an absolute length unit (e.g., cm, dm, and etc.).
4. The zone and zone group definitions. A zone definition can be represented by a collection of grid indexes, while a zone group is a collection of zones. The
   grid index can be defined in a sequence number manner that start from top left of the floorplan.
5. When defining zones and zone group with a graphical tool, the boundary of the zones should snap to the grid vertices to avoid one grid belongs to multiple
   zones.
      These above listed information may be communicated from a local server or from a remote server in the cloud to the mobile device at an initial handshake stage between the two devices. An example of an existing Application Programming Interface (API) function is a Get Venue API call for the device to get information about the building it is in.

As describe above, when the mobile device starts a handshake with a local server or a remote server in the cloud, information about the building floorplans will be communicated as part of the response of the getVenue API. An example of such data in JSON format is as follows:

```
  {
    ″floorplanImageWidth″: 1200,
    ″floorplanImageHeight″: 800,
    ″floorLevel″: 0,
    ″geoReference″: [
  {
    ″geoCoordinates″: {
    ″latitude″: 49.62951300586121,
    ″longitude″: 3.212659480879177
  },
    ″pixelCoordinates″: {
    ″x″: 748.3229740460713,
    ″y″: 848.679036458333
    }
  },
  {
    ″geoCoordinates″: {
    ″latitude″: 49.62899178408767,
    ″longitude″: 3.212165117263801
  },
    ″pixelCoordinates″: {
    ″x″: 22.562500896553185,
    ″y″: 236.61246386170387
  }
  },
  {
    ″geoCoordinates″: {
    ″latitude″: 49.62927124819141,
    ″longitude″: 3.213417171760682
  },
    ″pixelCoordinates″: {
    ″x″: 1353.7500573794048,
    ″y″: 253.35810160636902
  }
  }
],
″gridSizeX″: 3.2515,
″gridSizeY″: 3.2515,
″zones″: [
  {
    “name”: “zone1”,
    ″uuid″: 12793ade-bff1-48cc-b1c9-ab11e48161d3,
    ″gridList″: [1, 2, 3, 4, 100, 200 ......]
  },
  {
    “name”: “zone2”,
    ″uuid″: 25388ade-bff1-48cc-b1c9-ab11e4876abc,
    ″gridList″: [21,32, 53, 64, 1560, 20087 ......]
  },
],
“zoneGroups”: [
  {
    “name”: “zone group 1”
    ″uuid″: 55593ade-bff1-48cc-b1c9-ab11e481efac,
    ″zoneList″: [12793ade-bff1-48cc-b1c9-ab11e48161d3,
    25388ade-bff1-48cc-b1c9-ab11e4876abc,
    ]
  },
]
}
```

Different indoor positioning technologies may be used by the mobile devices for obtaining localization information, such as visible light communication (VLC), Bluetooth Low energy (BLE), Ultra-Wide Band (UWB), or a combination of multiple technologies. The location data that a mobile device reports to the cloud may look like the following in JSON format, which means the mobile device at time 2021-06-23T09:01:11 is at position (latitude, longitude)=(51.40675248055913, 5.460239092416265), with an accuracy of 0.4862756 meters.

```
  {
    “altitude”: 0.0,
    “dateTime”: “2021-06-23T09:01:11+00:00”,
    “floorLevel”: 0,
    “horizontalAccuracy”: 0.4862756,
    “latitude”: 51.40675248055913,
    “longitude”: 5.460239092416265
},
```

With the extra information provided at the handshake stage between mobile device and cloud service, the mobile device can map the above location (latitude, longitude) into a pixel position on the floorplan (x, y). The pixel position can be converted to grid index using the grid size.

$$I = CEIL ( \frac{y}{GSy} ) * CEIL ( \frac{W}{GSx} ) + CEIL ( \frac{x}{GSx} )$$

Here GSx and GSy is the grid size in x and y axes. W is the floorplan image x dimension.

Further information about which zone and zone group this location belongs to may also be derived based on the definition of zones and zone groups provided in the configuration information. The location data the mobile device reports to the cloud service then looks as:

```
{
  “altitude”: 0.0,
  “dateTime”: “2021-06-23T09:01:11+00:00”,
  “floorLevel”: 0,
  “horizontalAccuracy”: 0.4862756,
  “latitude”: 51.40675248055913,
  “longitude”: 5.460239092416265,
  “gridIndex”: 75532,
  “zone”: 12793ade-bff1-48cc-b1c9-ab11e48161d3,
  “zoneGroup”: 55593ade-bff1-48cc-b1c9-ab11e481efac
}
```

FIG. 2 illustrates an example of an indoor positioning system 100 according to the present invention. An indoor positioning system 100 comprises a local server 400 on premises configured to provide configuration information to a mobile device 200; and the mobile device 200 configured to: detect raw localization data; pre-process the raw location data by using the configuration information, upon determining to carry out preprocessing locally in the mobile device 200; send pre-processed localization data to the local server 400. As show in FIG. 2, there may be a plurality of mobile devices 200 in the field. Each mobile device 200 may be a mobile phone, a tablet, a laptop, a wearable device, a handheld scanner, or another portable electronic device. Different mobile devices 200 may have different computation capability, and then each of mobile devices 200 may determine whether to carry out the pre-processing on the raw localization data depending on its own capability and status.

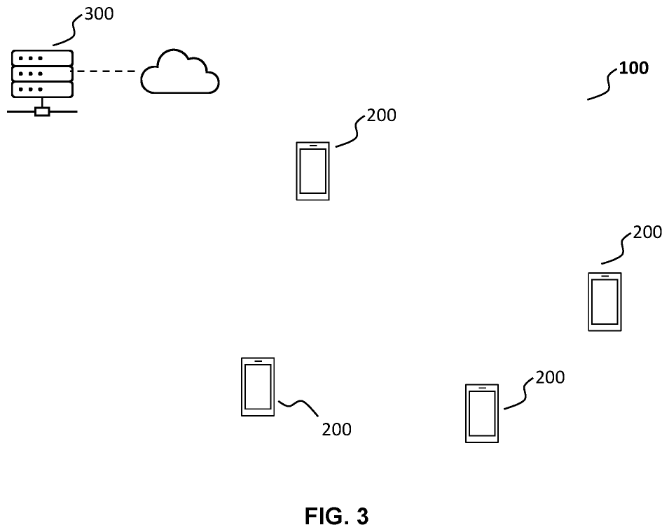

FIG. 3 illustrates another example of an indoor positioning system 100 according to the present invention. The indoor positioning system 100 comprises a cloud server 300 configured to provide configuration information to a mobile device 200; and the mobile device 200 configured to detect raw localization data; pre-process the raw location data by using the configuration information, upon determining to carry out preprocessing locally in the mobile device 200; send pre-processed localization data to the cloud server 300.

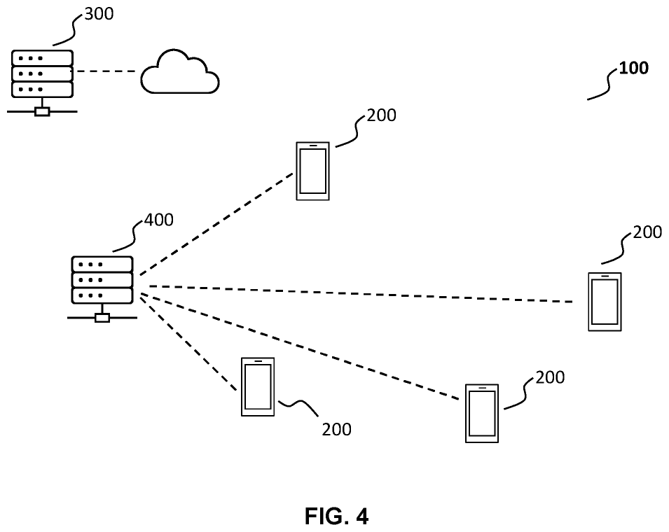

FIG. 4 illustrates a further example of an indoor positioning system 100 according to the present invention. The indoor positioning system 100 comprises a local server 400 configured to provide configuration information to a mobile device 200; a cloud server 300; and the mobile device 200 configured to: detect raw localization data; pre-process the raw location data by using the configuration information, upon determining to carry out preprocessing locally in the mobile device 200; send pre-processed localization data to the cloud server 300.

Upon receiving the localization data from one or more mobile devices, the local server or the cloud server can calculate the footfall, density and dwell time by aggregating relevant data, such as grouping data from mobile devices from the same location, the same zone, or the same zone group.

The pre-processing of the data in the mobile device locally may not be a problem for an advanced device, such as a high-end mobile phone, but it could be a burden for low end devices such as handheld scanner in a super-market. Furthermore, sometime the mobile device could be busy with some other important tasks in the background, thus cannot allocate sufficient resources on this dedicated data processing task. It is thus beneficial that the mobile device may first evaluate its capability and/or status and decide whether to run this pre-processing step. If a mobile device determines not to carry out preprocessing locally, it may simply send the raw localization data to the local server or the cloud server. If the mobile device determines that it is capable to carry out the preprocessing locally, it will first do the pre-processing locally and then send the pre-processed localization data to the local server or the cloud server. The pre-processed localization data may comprise the derived gridIndex, zone, and zoneGroup, or a subset of the information. The selection of data may depend on the application requirements.

It is also beneficial that the pre-processing results (e.g., gridIndex, zone, zoneGroup) are sent in combination with the raw localization data. The local server or the cloud server may still be capable to compute based on the raw localization data to derive some further information other than the gridIndex, zone, zoneGroup, or to derive the gridIndex, zone, zoneGroup in case one or more out of which are missing from the data received from the mobile device.

The cloud server may also try to optimize its computation resource, such that the cloud server may schedule the computing resources based on some pre-knowledge about the devices and the site, such as the processing capabilities of mobile devices and the business operation hours of the site that the mobile devices are located. For example, it is known that handheld scanners may not be capable of performing the computation locally. By knowing the business hours that the devices are operating, more cloud computing resources may be scheduled for the data pre-processing in the corresponding time period.

The methods according to the invention may be implemented on a computer as a computer implemented method, or in dedicated hardware, or in a combination of both.

Executable code for a method according to the invention may be stored on computer/machine readable storage means. Examples of computer/machine readable storage means include non-volatile memory devices, optical storage medium/devices, solid-state media, integrated circuits, servers, etc. Preferably, the computer program product comprises non-transitory program code means stored on a computer readable medium for performing a method according to the invention when said program product is executed on a computer.

Methods, systems, and computer-readable media (transitory and non-transitory) may also be provided to implement selected aspects of the above-described embodiments.

1. A data processing method for indoor positioning comprising steps of:
providing configuration information to a mobile device by a cloud server or a local server on premises;
detecting raw localization data by the mobile device;
pre-processing the raw localization data by using the configuration information, upon determining by the mobile device to carry out preprocessing locally;
sending pre-processed localization data to the cloud server or the local server on premises;
wherein the configuration information comprises a dimension in pixels of a floorplan and a grid size in pixels or in an absolute length unit, and the grid size is configurable and defines the precision of the pre-processed localization data;
wherein the pre-processing step further comprises:
mapping the raw localization data to a grid index; wherein the pre-processed localization data comprises the grid index.

2. The data processing method of claim 1 further comprising sending raw localization data to the cloud server or the local server.

3. The data processing method of claim 1, wherein the configuration information further comprises a zone definition represented by a collection of grid indexes.

4. The data processing method of claim 3, wherein the pre-processing step further comprises:
mapping the raw localization data to a zone index; wherein the pre-processed localization data comprises the zone index.

5. The data processing method of claim 3, wherein a zone is defined according to a category of products or a functional space.

6. The data processing method of claim 3, wherein the configuration information further comprises a zone group definition represented by a collection of zones.

7. The data processing method of claim 6, wherein the pre-processing step further comprises:
mapping the raw localization data to a zone group index; wherein the pre-processed localization data comprises the zone group index.

8. The data processing method of claim 1, wherein the raw localization data is detected by the mobile device via visible light communication, a Bluetooth Low Energy radio, an Ultra-wideband radio, or a combination therefrom.

9. (canceled)

10. An indoor positioning system comprising:
a local server on premises configured to provide configuration information to a mobile device; and
the mobile device configured to:
detect raw localization data;
pre-process the raw localization data by using the configuration information, upon determining to carry out preprocessing locally in the mobile device;
send pre-processed localization data to the local server;
wherein the configuration information comprises a dimension in pixels of a floorplan and a grid size in pixels or in an absolute length unit, and the grid size is configurable and defines the precision of the pre-processed localization data;
wherein the mobile device is further configured to map the raw localization data to a grid index to pre-process the raw localization data, and the pre-processed localization data comprises the grid index.

11. An indoor positioning system comprising:
a cloud server configured to provide configuration information to a mobile device; and
the mobile device configured to:
detect raw localization data;
pre-process the raw localization data by using the configuration information, upon determining to carry out preprocessing locally in the mobile device;
send pre-processed localization data to the cloud server;
wherein the configuration information comprises a dimension in pixels of a floorplan and a grid size in pixels or in an absolute length unit, and the grid size is configurable and defines the precision of the pre-processed localization data;
wherein the mobile device is further configured to map the raw localization data to a grid index to pre-process the raw localization data, and the pre-processed localization data comprises the grid index.

12. An indoor positioning system comprising:
a local server on premises configured to provide configuration information to a mobile device;
a cloud server; and
the mobile device configured to:
detect raw localization data;
pre-process the raw localization data by using the configuration information, upon determining to carry out preprocessing locally in the mobile device;
send pre-processed localization data to the cloud server;
wherein the configuration information comprises a dimension in pixels of a floorplan and a grid size in pixels or in an absolute length unit, and the grid size is configurable and defines the precision of the pre-processed localization data;
wherein the mobile device is further configured to map the raw localization data to a grid index to pre-process the raw localization data, and the pre-processed localization data comprises the grid index.

13. An indoor positioning system comprising:
a cloud server configured to provide configuration information to a mobile device;
a local server on premises; and
the mobile device configured to:
detect raw localization data;
pre-process the raw localization data by using the configuration information, upon determining to carry out preprocessing locally in the mobile device;
send pre-processed localization data to the local server;
wherein the configuration information comprises a dimension in pixels of a floorplan and a grid size in pixels or in an absolute length unit, and the grid size is configurable and defines the precision of the pre-processed localization data;
wherein the mobile device is further configured to map the raw localization data to a grid index to pre-process the raw localization data, and the pre-processed localization data comprises the grid index.

14. The indoor positioning system of claim 11, wherein the cloud server is configured to schedule computing resource on the cloud server for handling localization data submitted by a mobile device according to a processing capability of the mobile device and/or business hours of a site that the mobile device is located.
